(19) United States
(12) Patent Application Publication
(10) Pub. No.: US 2015/0227934 A1
(43) Pub. Date: Aug. 13, 2015

(54) METHOD AND SYSTEM FOR DETERMINING AND ASSESSING GEOLOCATION PROXIMITY

(71) Applicant: MASTERCARD INTERNATIONAL INCORPORATED, Purchase, NY (US)

(72) Inventor: Rohit Chauhan, Somers, NY (US)

(73) Assignee: MASTERCARD INTERNATIONAL INCORPORATED, Purchase, NY (US)

(21) Appl. No.: 14/177,877

(22) Filed: Feb. 11, 2014

(51) Int. Cl. G06Q 20/40; G06Q 20/32

(52) U.S. Cl. CPC G06Q 20/4016; G06Q 20/322

(57) ABSTRACT

A method and a system directed to location-based services within a wireless telecommunications or data communications network, and more particularly to other technical fields such as technologies used to authenticate secure payment card transactions, technologies to verify and validate payment card user identities, and for use with any application where the results of comparing two or more geographic locations has some utility or value. The method includes receiving information from a transaction device involving a payment card holder initiating a payment card transaction; identifying a location of the transaction device; identifying a location of a mobile device associated with the payment card holder; comparing the location of the transaction device with the location of the mobile device to determine a relative degree of proximity of the transaction device with the mobile device; and assessing the determined relative degree of proximity to determine whether the payment card transaction is valid or invalid.

### BACKGROUND OF THE DISCLOSURE

1. Field of the Disclosure

The present disclosure relates to systems and methods directed to location-based services in a wireless telecommunications or data communications network and, in particular, to determining and assessing geolocation proximity. More particularly, the present disclosure relates to such systems and methods directed to authenticating location-based services in a variety of spaces or technologies, such as authenticating secure payment card transactions, verifying and validating payment card user identities, and comparing the results of two or more geographic locations to provide utility or value.

2. Description of the Related Art

Payment card companies and merchants incur billions of dollars in losses each year from payment card fraud. Fraud is particularly high in the world of ecommerce where no payment card is actually presented for verification and the actual identity of the user performing the transaction is very difficult, if not impossible, to verify.

Some current fraud mitigation techniques include, for example, merchants requesting a payment card holder's zip code and payment card verification value (CVV) information to verify the identity of the payment card holder. Unfortunately, in a majority of the times when the payment card or the payment card number gets compromised, this information also gets compromised, thus reducing the efficacy of these additional pieces of information.

Another technique is for payment card companies to build detailed expensive models on payment card holder behaviors around purchase patterns (things they buy, stores they frequent, etc.) and geolocation movements (places the payment card holder typically travels to). These behaviors are compiled over time and continually evolve. The purchase models are used to detect fraud early and alert merchants and payment card holders. However, the models take months, if not years, to be built for each user and often result in false positives when a user breaks their pattern.

In recent years, the sudden surge in ecommerce and targeted marketing has resulted in user purchase patterns becoming more erratic and unpredictable. For example, a “good deal” will entice most people to click “Buy” on items they otherwise would not have thought of buying. This shift in behavior often results in false negatives if the model is too rigid and renders the model useless approving all transactions if it is made too flexible. The current system results in higher fraud levels on one end and higher customer service costs and more customer dissatisfaction on the other.

There exists a myriad of current methods that provide for authentication, verification and validation of user activity as well as for user identity. These technologies are used to ensure that an individual is the actual person claimed for the benefit of the activity or transaction. Today, many employed technologies have greatly reduced fraudulent transactions, however instances of fraudulent activity still occur. These technologies are employed, for example, when an individual engages in some transaction that requires some degree of security. An automated financial transaction is a common example of a secure transaction requiring mechanisms to authenticate, verify and validate the identity of the individual attempting to perform the transactional activity. Primary examples of such transactions include performing some banking function, using payment cards (e.g., credit or debit cards) at a point of sale (POS) to make a purchase, electronic commerce-based transactions (e-commerce) and online banking, where an individual enters financial information into a website form on a personal computer to make a purchase or to perform a financial activity, require some form of authentication, verification and validation.

Typical means that are used to authenticate individuals attempting a secure transaction include use of personal identification numbers (PINs) or some other type of information that is assumed to be known only by an authorized user involved in the transaction. Other means of documentation may also be used to verify identity, such as a driver's license or other form of photo identification. Even the use of biometric devices, such as fingerprint scanners, may be used to authenticate an individual attempting to perform a secure transaction. However, even with these and many other technologies employed, fraudulent activity still occurs, and identity theft and misrepresentation remains a problem.

As indicated above, many existing fraud detection and prevention technologies can and do provide a false positive indication of fraudulent activity. Besides the fraud detection and prevention mechanisms already mentioned, other technologies may be employed such as behavioral profiling that is used to detect anomalous behavior. These technologies employ intelligent algorithms to analyze past user behavior when a user attempts to engage in some activity or transaction that is similar to a previous activity or transaction. If the individual's behavior when engaging in a secure activity is not consistent with that individual's past behavior, a likelihood of fraudulent activity may be deduced.

Common examples of this situation are when an individual uses a payment card to purchase some product or service in a foreign country where they have never previously performed a similar transaction. Or, the amount of a particular transaction is significantly different from any previous transaction. This behavior may appear anomalous to a fraud detection system and the activity or transaction being performed may be terminated before any potential fraud is perpetrated. If this is in fact a false positive indication and the individual is actually an authorized user, the user suffers the consequences of a failed transaction and the service provider is perceived to have provided a poor quality of service.

Also, payment cards may be stolen and/or PINs may become compromised and information meant to be held only by authorized users may become known to others. The reality is that other means to perform authentication, verification and validation of authorized users to assist in an authentication process continues to have relevance for transactions where fraudulent activity remains a problem.

There is a need for additional and improved systems and methods to assist, for example, with fraud management systems and identity recognition and authentication. These systems are employed in a variety of industries, including banking and finance, commerce, security and others. In many cases, existing technologies employ detection methods as opposed to prevention methods. That is, many technologies and systems currently in place attempt to detect some fraudulent activity after it has occurred, and then prevent similar fraudulent activity in the future based on this detection. These methods are not optimal as fraudulent activity may be successful in at least one instance prior to detection and subsequent prevention. The prevention of the fraudulent activity the first instance an attempt is made to do so, is certainly preferable, as well as reducing incidences of false positive indications of fraud. No present fraud detection and prevention system is perfect. Thus, there is always a need to employ additional technologies to further reduce fraud and identity theft, thereby reducing the economic impact of such undesired activity.

### SUMMARY OF THE DISCLOSURE

The present disclosure provides systems and methods directed to location-based services in a wireless telecommunications or data communications network and, in particular, to determining and assessing geolocation proximity. The present disclosure also provides such systems and methods directed to authenticating location-based services in a variety of spaces or technologies in a wireless telecommunications or data communications network, such as authenticating secure payment card transactions, verifying and validating payment card user identities, and comparing the results of two or more geographic locations to provide or determine some utility or value. The present disclosure also provides methods and systems for payment card (or other online or electronic purchase) fraud alerting based on a payment card holder's location.

The present disclosure further provides a method that comprises receiving information from a transaction device involving a payment card holder initiating a payment card transaction; identifying a location of the transaction device; identifying a location of a mobile device associated with the payment card holder; comparing the location of the transaction device with the location of the mobile device to determine a relative degree of proximity of the transaction device with the mobile device; and assessing the determined relative degree of proximity to determine whether the payment card transaction is valid or invalid.

The present disclosure still further provides a method for authentication of a payment card transaction. The method comprises receiving information from a transaction device involving a payment card holder initiating a payment card transaction; identifying a location of the transaction device; identifying a location of a mobile device associated with the payment card holder; comparing the location of the transaction device with the location of the mobile device to determine a relative degree of proximity of the transaction device with the mobile device; and assessing the determined relative degree of proximity to determine whether the payment card transaction is valid or invalid.

The present disclosure yet further provides a system that comprises a computer storage storing information for a plurality of payment card holders and a plurality of merchants. The information for at least one of the payment card holders comprises information about location of a mobile device associated with the payment card holder, and the information for at least one of the merchants comprises information about location of a transaction device associated with a payment card transaction. The system includes a processor coupled to the computer storage operable to: receive information from the transaction device involving the payment card holder initiating a payment card transaction; identify a location of the transaction device; identify a location of the mobile device associated with the payment card holder; compare the location of the transaction device with the location of the mobile device to determine a relative degree of proximity of the transaction device with the mobile device; and assess the determined relative degree of proximity to determine whether the payment card transaction is valid or invalid.

The present disclosure additionally provides a non-transitory machine-readable medium that comprises a plurality of machine-readable instructions which when executed by one or more processors of a server are adapted to cause the server to perform a method. The method comprises receiving information from a transaction device involving a payment card holder initiating a payment card transaction; identifying a location of the transaction device; identifying a location of a mobile device associated with the payment card holder; comparing the location of the transaction device with the location of the mobile device to determine a relative degree of proximity of the transaction device with the mobile device; and assessing the determined relative degree of proximity to determine whether the payment card transaction is valid or invalid.

These and other features and advantages of the present disclosure will be more readily apparent from the detailed description of the embodiments set forth herein.

### BRIEF DESCRIPTION OF THE DRAWINGS

FIG. 1 is a diagram of a four party payment card system.

FIG. 2 is a flow diagram illustrating one environment of a process for payment card fraud alerting in accordance with an exemplary embodiment of this disclosure.

FIG. 3 is a diagram illustrating a process for payment card fraud alerting in accordance with an exemplary embodiment of this disclosure.

FIG. 4 is a block diagram of a networked system suitable for implementing the processes described herein according to an embodiment of this disclosure.

FIG. 5 is a block diagram of a computer system suitable for implementing one or more components in FIG. 4 according to one embodiment of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of this disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

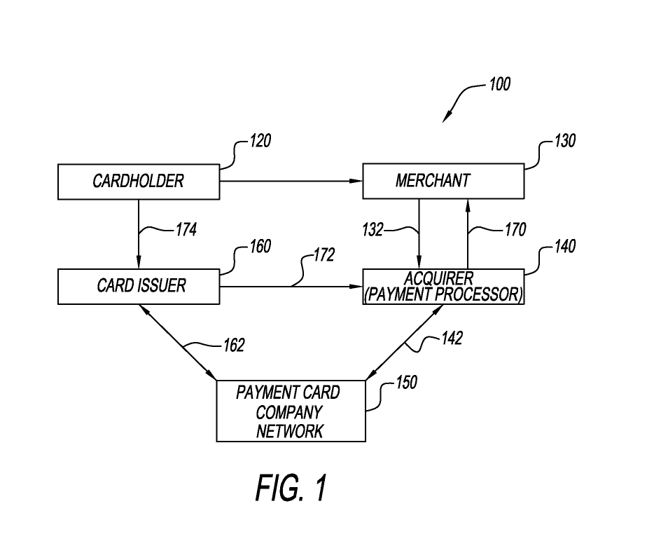

Referring to the drawings and, in particular, FIG. 1, there is shown a four party payment (e.g., credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the point-of-sale (POS) device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

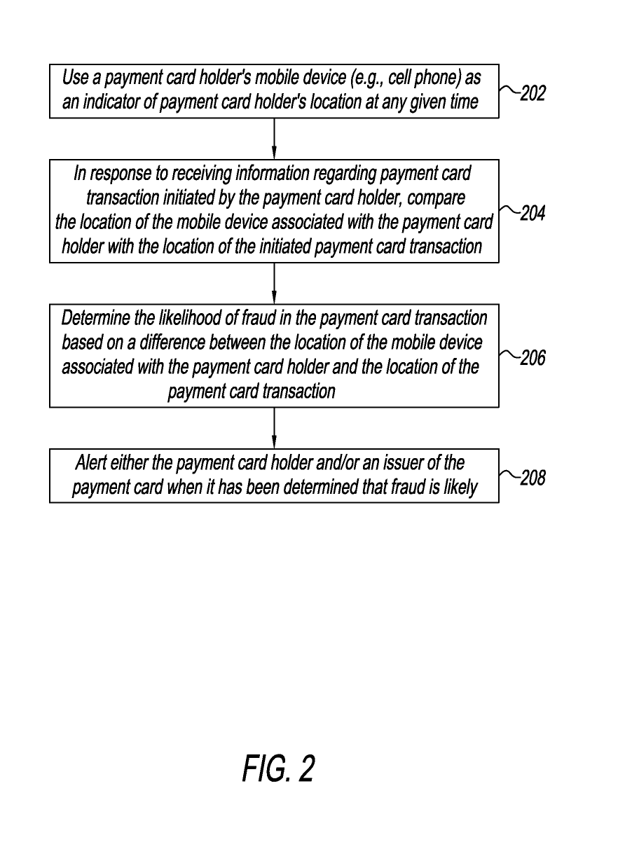

FIG. 2 illustrates one exemplary environment of a process for payment card fraud alerting. The exemplary embodiment recognizes that the location of a payment card holder is a critical piece of information that can alleviate significant amounts of fraud (as it is rare for a payment card holder associated with a cell phone to be too far from his or her cell phone). With the widespread adoption of mobile devices, such as a cell phone and more importantly smart phones, the exemplary embodiment uses a payment card holder's cell phone at 202 as an indicator of the payment card holder's location at any given time. The location can be obtained through conventional methods, such as a location service (e.g., global positioning system (GPS) service) in the phone, cellular phone “ping” data that includes geotemporal data, from a cell location register information held by the telecoms provider to which the phone is connected, and the like.

The location of the payment card holder's cell phone can be obtained, in one embodiment, after a payment provider, such as a payment card company like MasterCard®, Visa®, American Express®, and the like (part of the payment card company network 150 in FIG. 1), receives a payment request from a device. The payment request can be from a merchant or another user device, where the payment request includes information about the transaction, the seller or merchant location, an amount of the transaction. The location can be determined through a location service associated with the device from which the payment request is sent from or other means, such as a merchant ID associated with a merchant address stored in the payment provider database.

In response to receiving information regarding the payment request or payment card transaction of the payment card holder, the exemplary embodiment compares at 204 the location of the payment card holder (based on the location of the payment card holder's cell phone) with a location of the payment card transaction or payment request (based on the location of the payment request).

A likelihood of fraud in the payment card transaction is then determined at 206 based on a difference between the location of the payment card holder and the location of the payment card transaction. This difference can vary, depending on system fraud requirements, payment card holder settings, accuracy or resolution of the location determinations, and the like. For example, if the distance between the payment card holder mobile device and the transaction device is more than 250 or 500 meters, a possible fraud can be identified.

In a comparison of the location of the payment card holder mobile device with the location of the transaction device, if the location comparison results demonstrate close proximity of the mobile device associated with the payment card user to the transaction device or the payment card transaction being performed, a reasonable assertion can be made that the payment card user is authentic, or the payment card transaction being performed is valid. In contrast, if the location comparison results demonstrate far proximity of the mobile device associated with the payment card user to the transaction device or payment card transaction being performed, a reasonable assertion can be made that the payment card user is not authentic, or the payment card transaction being performed is invalid.

When it has been determined that fraud is likely, one of the following: the payment card holder, the merchant/seller, and/or an issuer of the payment card, can be alerted at 208. The alert can be through a text, email, or call to the payment card holder mobile device, the merchant, and/or the payment card issuer. In one embodiment, the payment card holder can be notified and given the option of authorizing the payment, such as by verifying the payment card holder through an authentication or login flow with the payment provider through the payment card holder mobile device.

The present solution utilizes the real time or last known location of a payment card holder's cell phone and compares it against the location of the payment card transaction to determine the propensity for fraud in a given transaction. The location of the payment card holder's mobile device (e.g., a cell phone, a watch phone, a personal digital assistant (PDA), a tablet computer, and the like) can be derived from an onboard GPS chip or via cell phone triangulation (depending on the device) and is sent up to server at regular intervals or when the device switches between cell towers for storage and analysis. This is done via software running on the device. This information is critical in obtaining up to date location on a payment card holder and, over time, builds a detailed model for travel and location patterns.

The location of the payment card transaction can include either a physical location of a merchant (e.g., a physical address of the merchant or an IP address of a point-of-sale (POS) terminal that is resolved to a geolocation), or a geolocation of an IP address of a device (e.g., a computer) used to execute the transaction by the payment card holder, merchant, or another purchaser.

Knowing the location of a payment card holder associated with the mobile device and comparing it to the location of the transaction, both in the physical world (location of the point of sale terminal) or in an online world (geo IP location of the computer/device used in the transaction), at the time of the transaction can vastly improve decision making on the legitimacy of the transaction. Because a payment card holder is assumed to always be near or have in his or her possession the payment card holder's cell phone, the location of the cell phone is assumed to be the payment card holder's approximate location. Consequently, if a payment request is made by the payment card holder or on behalf of the payment card holder at a location far from the payment card holder's cell phone, the payment provider can assume a potential of a fraudulent payment request. This may not always be the case though, such as in the situation where the payment card holder left the cell phone at the house and went to the mall to make a purchase. In this case, the cell phone location can be far away from the payment request location, but still be a proper purchase request. In this case, the merchant can be notified and request additional authentication or verification from the payment card holder, such as a driver's license.

The fraud alerting system uses the location of the payment card holder's mobile device and the computer used in the transaction to determine payment card fraud in several scenarios.

In a store purchase scenario, when a payment card holder swipes a payment card at a store to pay for goods/services, the physical location of the merchant/service provider is sent the bank/financial institution/payment provider and onto a server in the fraud alerting system where the physical location of the merchant/service provider is compared against the last known location of the payment card holder's cell phone in real-time. If the last known location as beaconed by the mobile device is recent and the distance between the mobile device and the merchant address is significant, an alert can be generated and sent to the mobile phone and/or the transaction can be pushed into a review queue or rejected.

Each merchant terminal contains a terminal ID and has a designated merchant address that is part of the transaction. At the time of the transaction, this terminal address is geolocation coded into a latitude/longitude. The latitude/longitude of the transaction is then compared to the last known mobile device location. The device location can be aged on an exponential scale (1/log(n)), so information that is current (recent) results in a high confidence; however location information that is hours or days old bears almost no confidence since the payment card holder may have moved. Confidence can be assigned by 1/(Log(current time-time of last location recording)+1). If the confidence is low, the system can attempt to obtain a current location of the payment card holder and/or payment card holder mobile device/cell phone.

The distance between the transaction location and the last known mobile phone location can be computed to determine the likelihood of the card holder being present at the POS terminal. When a recent location for the device is unknown, the payment card holder location can be predicted as described herein.

In an ecommerce purchase scenario, with a web purchase from a merchant website or app, the IP address or device ID of the browser/transacting device can be used to determine the location of the transaction. The fraud alerting system then compares the transaction location to the mobile device location to determine whether the mobile phone is within reasonable distance of the transacting device. A significant distance results in an alert and/or a rejection of the transaction.

At the time of the payment card transaction, the transaction device (such as a payment card holder's computer, a merchant terminal/server) IP address is captured and passed through with the transaction parameters. The IP address is then resolved to a geolocation. The geolocation of the transaction device (e.g., the payment card holder's computer) is then compared with the last known location of the mobile device associated with the account. Any distances over a threshold number of miles can result in a flag and/or alert.

Geo IP accuracy can vary from vendor to vendor. Poor accuracy in IP geo-location data can result in locating the transaction in wrong counties, wrong cities, or even states. In order to improve confidence and accuracy, the fraud alerting system service can pull the IP geolocation information across multiple providers and cluster the locations based on distances from each other. In many cases, a simple majority rule should suffice in determining which location is correct; however clustering the locations from various providers and then using the size of the largest cluster to determine a confidence in the location is an approach that has proven most effective.

Furthermore, with geolocation standards and modern browsers allowing users to geolocate themselves (using WIFI triangulation), it is possible to use data submitted by end users to score various IP geolocation data vendors for accuracy. This scoring for accuracy is then used in determining the weight or trust value to be assigned to the specific vendor for future IP geolocation lookups. This scoring is further refined by using characteristics of the IP address such as routing type, assignment, city, state, organization, and the like, to determine how specific vendors perform across each of these dimensions. For example, vendor A might perform very well (based on user submitted data) when the organization field is set or when the country for the IP address is UK and perform poorly when the connection type is DSL or dialup.

This is significant because a fraud perpetrator gaining access to a payment card holder's payment card or the digits of the payment card will also need to be in possession of the payment card holder's cell phone. If the cell phone is not within the same geolocation boundary, the payment card transaction will result in the payment card holder being alerted and/or the transaction being put in a review queue.

The fraud alerting system enables consumers to link specific devices to their payment card account and only transactions originating from those devices are permitted to carry out transactions using the specific payment account. All other payment card transactions result in alerts sent to the payment card holder's mobile device and/or end up in review queues.

When a new device is determined by the fraud alerting system, the device is fingerprinted using parameters unique to the device, including operating system, screen resolution, browser information, plug-in, extension DLLs, IP geolocation, and the like. A device ID is a unique identifier that enables the fraud alerting system servers to identify the device even if the payment card holder decides to delete all cookies and shared objects that may be written into the browser's cache by the fraud alerting system servers. In one embodiment, the device ID comprises of two pieces: 1) a unique hash of various parameters identifying the payment card holder's computer system, and 2) a randomly generated ID that is guaranteed to be unique for very unlikely cases where two devices use the exact same system configuration.

The device ID is written to the browser's cookie store but is also maintained on the fraud alerting system along with the computer's IP address. Keeping a copy of the fingerprint on the server allows the system to query the fingerprint given the device parameters and the IP address even if the payment card holder accidentally or intentionally deletes all their cookies.

Payment card holders logging into a bank's website/app, payment provider website/app, or their payment card provider's website/app, can add specific devices to their “authorized list.” When the payment card holder authorizes a computer, the fingerprint of the computer is saved in a secure digital locker, and added to the payment card holder's access list.

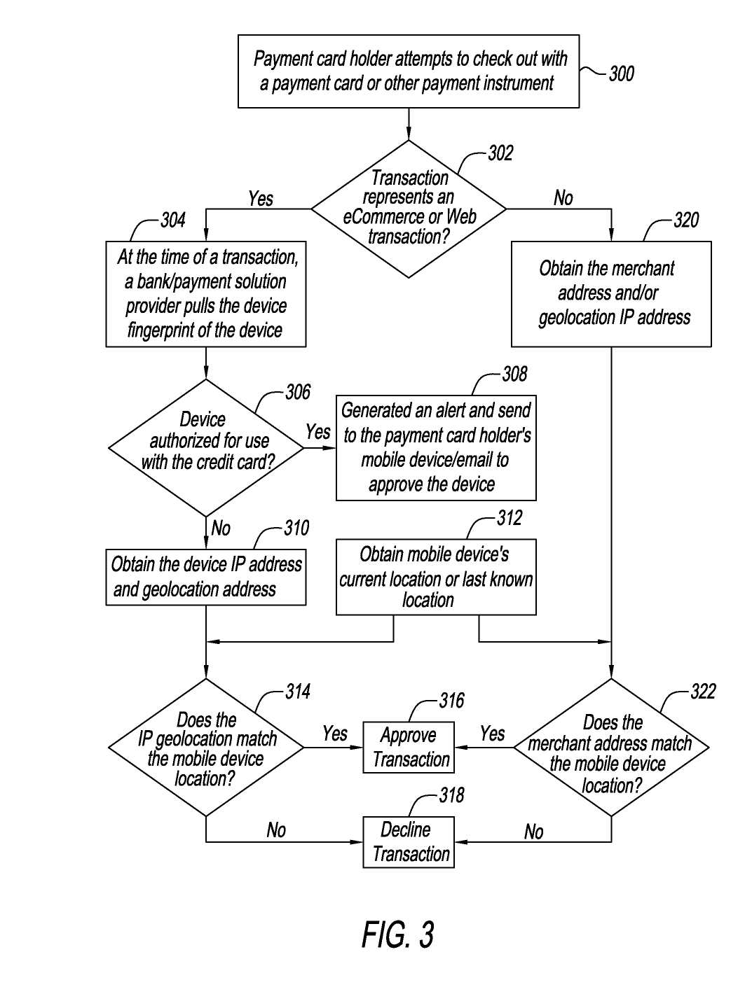

FIG. 3 illustrates a process for payment card fraud alerting in accordance with an exemplary embodiment. The process can begin at 300 with the payment card holder attempting to check out with a payment card or other payment instrument, such as payment card. It is then determined at 302 whether the payment card transaction represents an eCommerce or Web transaction or other transaction through a computing device, such as through a mobile app. If it is determined to be an eCommerce or Web (or app) transaction, then at the time of a transaction, a bank/payment solution provider may pull at 304 the device fingerprint of the device, such as the payment card holder's home or work PC, on which the transaction is being performed.

It is then determined at 306 if the transaction device is authorized for use with the payment card or payment instrument. This can be done by checking the fingerprint against the payment card holder's authorized access list and digital locker to establish trust with the device. If the transaction device is not on the authorization access list, an alert is generated at 308 and sent to the payment card holder's mobile device/email to approve the device. This can be carried out in real time or can be sent asynchronously requesting authorization within a certain number of hours or days. The payment card holder can revoke authority from a device at any given time by simply accessing their digital locker either via their mobile phone or via the web and removing the device fingerprint of the device in question (e.g., when the device is lost, broken, or stolen).

If the device is not authorized for a given payment card or payment system, the device IP address and geolocation address are obtained at 310. The mobile device's current location or last known location is also obtained at 312. The IP geolocation and the mobile device location are then compared at 314 to determine if they match within a predefined distance threshold. If so, the transaction is approved at 316, assuming other conditions are met, such as a successful payment card holder login. If not, the transaction may be declined and/or an alert generated and sent at 318.

If the location comparison results demonstrate close proximity of the mobile device location to the IP geolocation, a reasonable assertion can be made that the payment card user is authentic, or the payment card transaction being performed is valid. In contrast, if the location comparison results demonstrate far proximity of the mobile device location to the IP geolocation, a reasonable assertion can be made that the payment card user is not authentic, or the payment card transaction being performed is invalid.

If the transaction is determined not to be an eCommerce or Web (or app) transaction, the merchant address and/or the merchant geolocation IP address are obtained at 320. The mobile device's current location or last known location is also obtained at 312. It is then determined at 322 if the merchant address matches the mobile device location within a predefined distance threshold. If so, the transaction is approved at 316. If not, the transaction can be declined and/or an alert generated and sent at 318.

Knowing where a person is at any given time has many applications. Some of the applications could include locality specific advertising, social networking (showing where friends might be on a map) and in fraud mitigation. If the cell phone location could be queried continuously or if the cell phone proactively reports its location in a frequent periodic fashion, there can be no need for any further optimizations.

Unfortunately, getting the location of a cell phone may not always be possible. For example, doing so can result in the loss of battery power quickly. Also, phones can be powered off during flights, in cinemas, during meetings, night time, to save power, and the like, and phones often enter zones with limited/no connectivity.

When a cell phone location is unavailable, there can be methods to predict a possible set of locations of a payment card holder. In one method, heuristics are used. Based on previous geolocation movement patterns/locations for specific times of day, days of week, and days of the year, the fraud alerting system can build patterns in geolocation movement across time. If at any time the cell phone location cannot be extracted, it can be computed based on last known location, a heading, velocity of travel (computed based on last known geolocations in a given travel segment) and a match to previous geolocation movement patterns.

In another method, the last known location is used. The last known location information can be quite valuable in computing possible new locations for a person. The presence of a high speed rail, ferry service or airport can aid in creating a geolocation fence for the payment card holder's location even when the location information is no longer available from a mobile device. For example, if the last location is near (within 5 miles) an airport, the fraud alerting system can compute a potential area (circle around last location) where the payment card holder could be after a certain amount of elapsed time. This circle of presence could be further augmented by pulling in airline departure information, average aircraft speeds, and flight departure and destination list. The rate of change of radius of the circle (geofence) is tightly correlated with specific information related to the last known location (was it an airport, high speed rail terminal, bus station, and the like)/available options for travel, previous heading and potential velocity information.

In a fraud mitigation application, building regular patterns of travel can significantly aid in locating the payment card holder. Furthermore, when a person is located near an international airport and then transactions appear from an international location after many hours, it is possible to compute the possibility of whether a person may actually be at the international location. This information is extremely valuable, especially in authorizing international payment card or payment transactions if it is possible that the authorized payment card holder has travelled internationally. On the flip side, if the last known location for a person puts the transaction outside a geolocation fence given a certain amount of elapsed time, then the transaction can be instantly declined or at least flagged for follow up or additional analysis.

In accordance with this disclosure, even when a recent or real-time cell phone location cannot be obtained, the system can still be able to predict location(s) with enough certainty to allow the system to issue a fraud alert, as described herein, based on the payment card transaction or transaction device location and a predicted payment card holder's cell phone location.

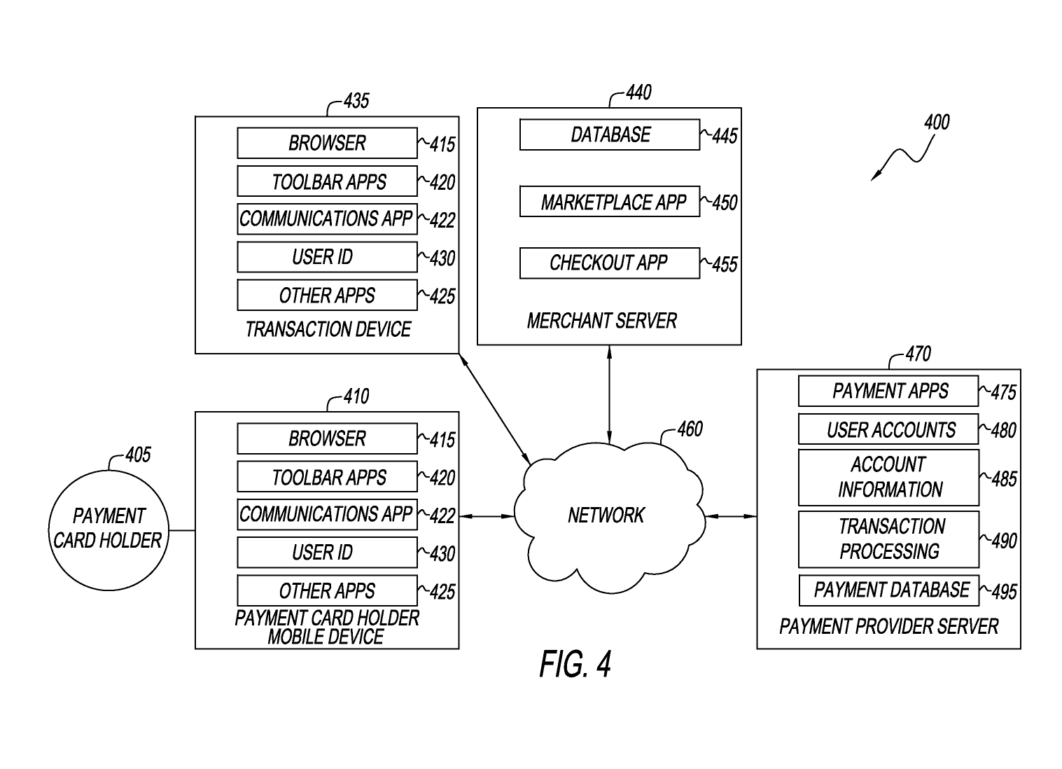

Referring to FIG. 4, a networked system 400 is configured to process a financial transaction or payment request between a payment recipient (e.g., merchant) and a payment sender (e.g., payment card holder or consumer), such as described above, in accordance with an exemplary embodiment of the present disclosure. System 400 includes a mobile device associated with a payment card holder 410, a transaction device 435, a merchant server 440, and a payment provider server 470 in communication over a network 460. Payment provider server 470 can be maintained by a payment provider, such as a payment card company like MasterCard®, Visa®, American Express®, and the like (part of the payment card company network 150 in FIG. 1), a bank, and the like. A payment card holder 405, such as a consumer, can utilize payment card holder mobile device 410 (or transaction device 435) to perform a payment transaction with merchant server 440 using payment provider server 470 or to convey a desire to make a payment through the payment provider so that the payment provider can process the payment request and approve or deny the request.

Payment card holder mobile device 410, transaction device 435, merchant server 440, and payment provider server 470 can each include one or more processors, memories, and other appropriate components for executing instructions, such as program code and/or data stored on one or more computer readable mediums to implement the various applications, data, and steps described herein. For example, such instructions can be stored in one or more computer readable media, such as memories or data storage devices internal and/or external to various components of system 400, and/or accessible over network 460.

Network 460 can be implemented as a single network or a combination of multiple networks. For example, in various embodiments, network 460 can include the Internet or one or more intranets, landline networks, wireless networks, and/or other appropriate types of networks.

Payment card holder mobile device 410 can be implemented using any appropriate hardware and software configured for wired and/or wireless communication over network 460. For example, in one embodiment, the payment card holder mobile device can be implemented as a personal computer (PC), a smart phone, personal digital assistant (PDA), laptop computer, and/or other types of computing devices capable of transmitting and/or receiving data, such as an iPad™.

Payment card holder mobile device 410 can include one or more browser applications 415 which can be used, for example, to provide a convenient interface to permit payment card holder 405 to browse information available over network 460. For example, in one embodiment, browser application 415 can be implemented as a web or mobile browser configured to view information available over the Internet. Payment card holder mobile device 410 can also include one or more toolbar applications 420 which can be used, for example, to provide client-side processing for performing desired tasks in response to operations selected by payment card holder 405. In one embodiment, toolbar application 420 can display a user interface in connection with browser application 415.

Payment card holder mobile device 410 can further include other applications 425 as may be desired in particular embodiments to provide desired features to payment card holder mobile device 410. For example, other applications 425 can include security applications for implementing client-side security features, programmatic client applications for interfacing with appropriate application programming interfaces (APIs) over network 460, or other types of applications. Applications 425 can also include email, texting, voice and IM applications that allow payment card holder 405 to send and receive emails, calls, and texts through network 460, as well as applications that enable the payment card holder to communicate, place orders, make payments, and change payment options through the payment provider.

Payment card holder mobile device 410 includes one or more payment card holder identifiers 430 that can be implemented, for example, as operating system registry entries, cookies associated with browser application 415, identifiers associated with hardware of payment card holder mobile device 410, or other appropriate identifiers, such as used for payment/user/device authentication. In one embodiment, payment card holder identifier 430 can be used by a payment service provider to associate payment card holder 405 with a particular account maintained by the payment provider as further described herein. A communications application 422, with associated interfaces, enables payment card holder mobile device 410 to communicate within system 400, such as via a cell phone network. Communications application 422 can also include a GPS service or other location service that enables the location of payment card holder mobile device 410 to be determined by payment provider server 470. Note that in different embodiments, payment card holder mobile device 410 can be a simple cell phone with includes, at a minimum, a location determining application and may not require some the applications and capabilities above.

Transaction device 435 can be the same or similar to payment card holder mobile device 410 as described above. In one embodiment, payment card holder mobile device 410 is a cell phone or smart phone, while transaction device is a PC or merchant terminal (such as a POS). Transaction device 435 can be the device that transmits a payment request to the payment provider on behalf of the payment card holder.

Merchant server 440 can be maintained, for example, by a merchant or seller offering various products and/or services in exchange for payment to be received over network 460. Generally, merchant server 440 can be maintained by anyone or any entity that receives money, which includes charities as well as retailers and restaurants. Merchant server 440 includes a database 445 identifying available products and/or services (e.g., collectively referred to as items) that can be made available for viewing and purchase by payment card holder 405. Merchant server 440 also includes a marketplace application 450 that can be configured to serve information over network 460 to browser 415 of payment card holder mobile device 410. In one embodiment, payment card holder 405 can interact, either through payment card holder mobile device 410 or transaction device 435, with marketplace application 450 through browser applications over network 460 in order to view various products, food items, or services identified in database 445. Merchant server 440 can also communicate directly with transaction device 435, such as when transaction device is a merchant terminal.

Merchant server 440 also includes a checkout application 455 that can be configured to facilitate the purchase by payment card holder 405 of goods or services identified by marketplace application 450. Checkout application 455 can be configured to accept payment information from or on behalf of payment card holder 405 through payment service provider server 470 over network 460. For example, checkout application 455 can receive and process a payment confirmation or payment options from payment service provider server 470, as well as transmit transaction information to the payment provider and receive information from the payment provider, including fraud alerts as described herein.

Payment provider server 470 can be maintained, for example, by an online payment service provider, payment card company like MasterCard®, Visa®, American Express®, and the like (part of the payment card company network 150 in FIG. 1), or bank, which can provide payment between payment card holder 405 and the operator of merchant server 440. In this regard, payment provider server 470 includes one or more payment applications 475 that can be configured to interact with payment card holder mobile device 410, transaction device 435, and/or merchant server 440 over network 460 to facilitate the purchase of goods or services by payment card holder 405 through payment card holder mobile device 410 or transaction device 435.

Payment provider server 470 also maintains a plurality of payment card holder accounts 480, each of which can include account information 485 associated with individual payment card holders. For example, account information 485 can include private financial information of payment card holders associated with mobile devices such as account numbers, passwords, device identifiers, payment card holder names, phone numbers, payment card information, bank information, or other financial information that can be used to facilitate online transactions by payment card holder 405. Advantageously, payment application 475 can be configured to interact with merchant server 440 and/or transaction device 435 on behalf of payment card holder 405 during a transaction with checkout application 455 to track and manage payment requests from the payment card holder. Payment card holder accounts can also contain information about one or more mobile devices associated with the payment card holder and the payment card holder account, such as a device ID, IP address, current location of device, history of device locations, and other information about device location as described herein, such as direction of movement.

A transaction processing application 490, which can be part of payment application 475 or separate, can be configured to receive information from a payment card holder's mobile device, transaction device and/or merchant server 440 for processing and storage in a payment database 495. Transaction processing application 490 can include one or more applications to process information from payment card holder 405 for processing a payment request or one or more locations of payment card holder mobile device 410, transaction device 435, and/or merchant server 470. As such, transaction processing application 490 can store details of a payment request, including merchant location and device locations to determine a possible fraud alert for the transaction. Payment application 475 can be further configured to determine the existence of and to manage accounts for payment card holder 405, as well as create new accounts if necessary.

Payment database 495 can store transaction details from completed transactions, including location of the transaction and payment card holder's mobile device. Such information can also be stored in a third party database accessible by the payment provider and/or the merchant.

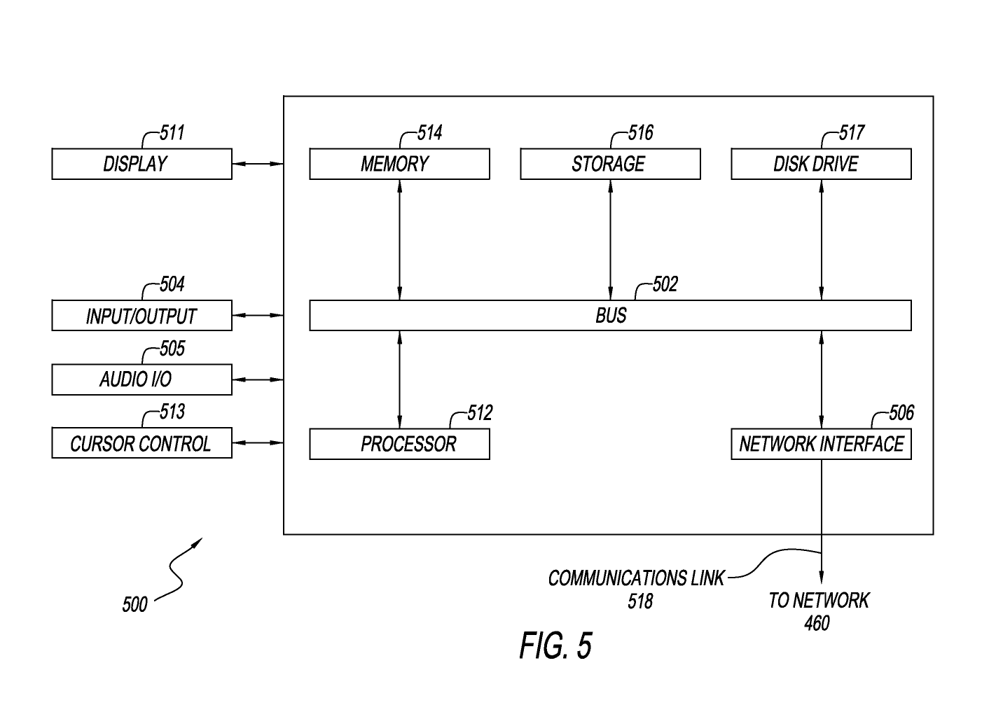

FIG. 5 is a computer system 500 suitable for implementing one or more embodiments of the present disclosure. In various implementations, the payment card holder's mobile device can comprise a personal computing device (e.g., a personal computer, laptop, smart phone, tablet, PDA, Bluetooth device, key FOB, badge, and the like) capable of communicating with the network. The merchant and/or payment provider can utilize a network computing device (e.g., a network server) capable of communicating with the network. It should be appreciated that each device utilized by payment card holders, merchants, and payment providers can be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, and the like, and sends a corresponding signal to bus 502. I/O component 504 can also include an output component, such as a display 511 and a cursor control 513 (such as a keyboard, keypad, mouse, etc.). An optional audio input/output component 505 can also be included to allow a user to use voice for inputting information by converting audio signals. Audio I/O component 505 allows the user to hear audio. A transceiver or network interface 506 transmits and receives signals between computer system 500 and other devices, such as another user device, a merchant server, or a payment provider server via network 460. In one embodiment, the transmission is wireless, although other transmission mediums and methods can also be suitable. A processor 512, which can be a micro-controller, digital signal processor (DSP), or other processing component, processes these various signals, such as for display on computer system 500 or transmission to other devices via a communication link 518. Processor 512 can also control transmission of information, such as cookies or IP addresses, to other devices. A GPS chip can be part of or separate from processor 512 to enable the location of computer system 500 to be determined.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic can be encoded in a computer readable medium, which can refer to any medium that participates in providing instructions to processor 512 for execution. Such a medium can take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media can take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure can be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) can perform instruction sequences to practice the present disclosure in coordination with one another.

The present disclosure provides methods and systems for payment card (or other online or electronic purchase) fraud alerting based on a payment card holder's location. Aspects of exemplary environment include using a location of a payment card holder's mobile device to obtain an indication of a location of the payment card holder, in response to receiving information regarding payment card or other transaction of the payment card holder; comparing the location of the payment card holder with a location of the payment card transaction; determining a likelihood of fraud in the payment card transaction based on a difference between the location of the payment card holder and the location of the payment card transaction; and alerting at least one of the payment card holder and an issuer of the payment card when a likelihood of fraud has been determined.

In accordance with this disclosure, the location of the payment card transaction can include either a physical location of a merchant for in-store transaction or a geolocation of an internet protocol (IP) address of a device used to conduct the payment card transaction by the payment card holder or another purchaser during a web transaction. In a different embodiment, the transaction need not be based on a payment card, but can be for an electronic payment using other payment provider services.

In accordance with this disclosure, to provide authentication or additional authentication confidence where individuals attempt to perform some automated secure transaction or activity, the location of the secure transaction or activity can be ascertained from the network that is being accessed via the transactional application. As the use of wireless devices has become ubiquitous, it is reasonable to assume that individuals carrying such a device would have the device with them while attempting to engage in a secure transaction or activity. In this case, comparing the location of the wireless device obtained from the wireless network with the location where the payment card holder associated with the wireless device is attempting to engage in a secure payment card transaction or activity, provides resultant information that can be used to authenticate, verify or validate that the payment card holder is in fact who he or she claims to be. Moreover, if the result from such a geographic location comparison reveals that the wireless device is in some location other than where the secure transaction or activity is taking place, it may be reasonably assumed that the payment card holder is not who he or she claims to be.

Depending on the resolution of the geographic locations obtained from both the wireless network and some other data communications network where an activity or payment card transaction occurs, varying degrees of confidence can be ascertained as to the authenticity of that activity or payment card transaction. False positive indications of anomalous behavior can also be avoided. An example is when an individual performs an activity or payment card transaction and that individual is in a significantly different location than previously visited but that individual is in fact who he/she claims to be.

Besides the mitigation of fraudulent activity, knowledge of the location of one or more individuals for use in value-added applications can be useful. Such knowledge of both the location of a wireless device, as well as the location of the wireless device user performing some automated activity or payment card transaction, can provide utility regardless of whether that activity requires security. Many value-added applications can benefit from such comparative geographic location information such as social networking applications or multi-player online gaming applications where it may be desirable for an individual to know the proximity of friends with which they wish to communicate. These friends may be engaging in some automated activity where the application is connected to a computer network where location information can be ascertained or they may be wireless device users themselves where the location of their wireless devices can be obtained from the same or another wireless network.

In accordance with this disclosure, the automated fraud detection and prevention systems can assign a value or range of values indicating the likelihood of fraudulent activity. These assigned values can depend on the security level required for a particular payment card transaction or activity as well as the methods used to indicate fraud. Such a mechanism can also be employed when the comparison of two or more locations, at least one being the location of a wireless device obtained from a wireless network, results in the ability to ascertain varying degrees of confidence based on the proximity of the two geographic locations being compared.

In particular, if the location comparison results demonstrate close proximity of a mobile device associated with the payment card user to the payment card transaction being performed, a reasonable assertion can be made that the payment card user is authentic, or the payment card transaction being performed is valid. In contrast, if the location comparison results demonstrate far proximity of the mobile device associated with the payment card user to the payment card transaction being performed, a reasonable assertion can be made that the payment card user is not authentic, or the payment card transaction being performed is invalid.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the scope of the present disclosure. In addition, where applicable, it is contemplated that software components can be implemented as hardware components and vice-versa.

Software, in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
receiving information from a transaction device involving a payment card holder initiating a payment card transaction;
identifying a location of the transaction device;
identifying a location of a mobile device associated with the payment card holder;
comparing the location of the transaction device with the location of the mobile device to determine a relative degree of proximity of the transaction device with the mobile device; and
assessing the determined relative degree of proximity to determine whether the payment card transaction is valid or invalid.

2. The method of claim 1, wherein the transaction device is a personal computer (PC) or a merchant point-of-sale (POS) terminal.

3. The method of claim 1, wherein identifying the location of the transaction device comprises obtaining an internet protocol (IP) address from the transaction device.

4. The method of claim 1, wherein the mobile device associated with the payment card holder is a cell phone or a smart phone.

5. The method of claim 1, wherein identifying the location of the mobile device comprises obtaining an address from an onboard global positioning system (GPS) chip or via cell phone triangulation.

6. The method of claim 1, wherein identifying the location of the mobile device comprises using a last known location of the mobile device based on a location service on the mobile device.

7. The method of claim 1, wherein identifying the location of the mobile device comprises predicting a current location of the mobile device based on a last known location of the mobile device and one factor selected from the group consisting of a type of the last known location, a type of an area of the last known location, a direction of travel of the mobile device, and a speed of travel of the mobile device.

8. The method of claim 1, wherein the payment card transaction is an eCommerce payment card transaction.

9. The method of claim 1, further comprising:
determining a distance between the location of the transaction device and the location of the mobile device; and
communicating an alert if the distance exceeds a predetermined distance.

10. A method for authentication of a payment card transaction, said method comprising:
receiving information from a transaction device involving a payment card holder initiating a payment card transaction;
identifying a location of the transaction device;
identifying a location of a mobile device associated with the payment card holder;
comparing the location of the transaction device with the location of the mobile device to determine a relative degree of proximity of the transaction device with the mobile device; and
assessing the determined relative degree of proximity to determine whether the payment card transaction is valid or invalid.

11. A system comprising:
a computer storage storing information for a plurality of payment card holders and a plurality of merchants, wherein the information for at least one of the payment card holders comprises information about location of a mobile device associated with the payment card holder, and the information for at least one of the merchants comprises information about location of a transaction device associated with a payment card transaction; and
a processor coupled to the computer storage operable to:
receive information from the transaction device involving the payment card holder initiating a payment card transaction;
identify a location of the transaction device;
identify a location of the mobile device associated with the payment card holder;
compare the location of the transaction device with the location of the mobile device to determine a relative degree of proximity of the transaction device with the mobile device; and
assess the determined relative degree of proximity to determine whether the payment card transaction is valid or invalid.

12. The system of claim 11, wherein the transaction device is a personal computer (PC) or a merchant point-of-sale (POS) terminal.

13. The system of claim 11, wherein the mobile device associated with the payment card holder is a cell phone or a smart phone.

14. The system of claim 11, wherein the processor operable to identify the location of the mobile device obtains an address from one of the following selected from the group consisting of an internet protocol (IP) address from the transaction device, an onboard global positioning system (GPS) chip, and via cell phone triangulation.

15. The system of claim 11, wherein the processor operable to identify the location of the mobile device uses a last known location of the mobile device based on a location service on the mobile device.

16. The system of claim 11, wherein the processor operable to identify the location of the mobile device predicts a current location of the mobile device based on a last known location of the mobile device and at least one factor selected from the group consisting of a type of the last known location, a type of an area of the last known location, a direction of travel of the mobile device, and a speed of travel of the mobile device.

17. The system of claim 11, wherein the payment card transaction is an eCommerce payment card transaction.

18. The system of claim 11, further comprising:
the processor coupled to the computer storage operable to:
determine a distance between the location of the transaction device and the location of the mobile device; and
communicate an alert if the distance exceeds a predetermined distance.

19. A non-transitory machine-readable medium comprising a plurality of machine-readable instructions which when executed by one or more processors of a server are adapted to cause the server to perform a method comprising:
receiving information from a transaction device involving a payment card holder initiating a payment card transaction;
identifying a location of the transaction device;
identifying a location of a mobile device associated with the payment card holder;
comparing the location of the transaction device with the location of the mobile device to determine a relative degree of proximity of the transaction device with the mobile device; and
assessing the determined relative degree of proximity to determine whether the payment card transaction is valid or invalid.

20. The non-transitory machine-readable medium of claim 19, wherein identifying the location of the transaction device comprises obtaining an IP address from the transaction device.

21. The non-transitory machine-readable medium of claim 19, wherein identifying the location of the mobile device comprises at least one step selected from the group consisting of obtaining an address from an onboard GPS chip or via cell phone triangulation, using a last known location of the mobile device based on a location service on the mobile device, and predicting a current location of the mobile device based on a last known location of the mobile device and at least one factor selected from the group consisting of a type of the last known location, a type of an area of the last known location, a direction of travel of the mobile device, and a speed of travel of the mobile device.
